(19) United States
(12) Patent Application Publication
(10) Pub. No.: US 2026/0299851 A1
(43) Pub. Date: Oct. 1, 2026

(54) PRINTER

(71) Applicant: BROTHER KOGYO KABUSHIKI KAISHA, Nagoya (JP)

(72) Inventor: Kazuhide SAWADA, Nagoya (JP)

(73) Assignee: BROTHER KOGYO KABUSHIKI KAISHA, Nagoya (JP)

(21) Appl. No.: 19/573,806

(22) Filed: Mar. 20, 2026

(30) Foreign Application Priority Data
Apr. 1, 2025 (JP) 2025-060566

(51) Int. Cl. G06F 3/12

(52) U.S. Cl. CPC G06F 3/1255; G06F 3/1204; G06F 3/1228; G06F 3/1232; G06F 3/1287

(57) ABSTRACT

A printer comprises a printing engine and a communication interface. The printer is configured to receive a print job from an IPP client and cause the printing engine to perform printing, and, in response to receiving a specific command requesting capability information from the IPP client, return capability information. The specific command includes a parameter including a capability parameter specifying a capability and a processing parameter specifying a process. The printer is further configured to return the capability information indicating a capability specified by the capability parameter in a case where the received specific command includes the capability parameter, and execute the process specified by the processing parameter in a case where the received specific command includes the processing parameter.

### REFERENCE TO RELATED APPLICATIONS

This application claims priority under 35 U.S.C. § 119 from Japanese Patent Application No. 2025-060566 filed on Apr. 1, 2025. The entire subject matter of the application is incorporated herein by reference.

### BACKGROUND ART

The technical field disclosed in this specification relates to a printer that is capable of operating in accordance with an IPP (Internet Printing Protocol) standard.

In recent years, a technology has been put into practical use in which a printer is controlled by a general-use printing program of an operating system (OS), which is a program that conforms to an IPP standard, without using a printer driver provided by a printer vendor. In this technology, when the OS detects the printer, the OS associates the printer with the general-use printing program, and thereafter, when a print instruction for the printer is received, the general-use printing program generates print data without using the printer driver provided by the printer vendor, thereby enabling printing by the general-use printing program.

However, printing performed by the general-use printing program of the OS may not fully utilize functions of the printer. For example, a printer that is capable of operating in accordance with the IPP standard may have a proprietary function that cannot be realized by the IPP standard, and thus a capability possessed by the printer may not be fully utilized.

### SUMMARY

According to aspects of the present disclosure, a printer includes a printing engine, and a communication interface. The printer is configured to, in accordance with Internet Printing Protocol (IPP), receive a print job from an IPP client through the communication interface and cause the printing engine to perform printing based on the received print job. The printer is configured to, in response to receiving a specific command from the IPP client through the communication interface, the specific command being defined by an IPP standard and requesting capability information, return the capability information indicating a capability of the printer, the specific command being capable of including a parameter, the parameter having a plurality of types, and the plurality of types including a capability parameter specifying a capability and a processing parameter specifying a process. The printer is further configured to in a case where the received specific command includes the capability parameter, return the capability information including a capability specified by the capability parameter among capabilities of the printer, and in a case where the received specific command includes the processing parameter, execute a process specified by the processing parameter.

According to aspects of the present disclosure, a printer includes a printing engine, and a communication interface. The printer is configured to, in accordance with Internet Printing Protocol (IPP), receive a print job from an IPP client through the communication interface and cause the printing engine to perform printing based on the received print job. The printer is configured to, in response to receiving a specific command from the IPP client through the communication interface, the specific command being defined by an IPP standard and requesting capability information, return the capability information indicating a capability of the printer, identification information for identifying the IPP client as a requester being associated with the specific command, the specific command being capable of specifying a process. The printer is further configured to in a case where the received specific command has been associated with the identification information indicating a first type IPP client, be capable of returning the capability information and executing the process specified by the specific command, and in a case where the received specific command has been associated with the identification information indicating a second type IPP client, be capable of returning the capability information, while not executing the process specified by the specific command.

### BRIEF DESCRIPTION OF THE DRAWINGS

FIG. 1 is a block diagram schematically illustrating an electrical configuration of an MFP.

FIG. 2 is a sequence diagram illustrating an example of a printing procedure.

FIG. 3 is a flowchart illustrating an example of a procedure of parameter determination process.

FIG. 4 is a flowchart illustrating an example of a procedure of response capability determination process.

FIG. 5 is an explanatory diagram illustrating examples of respondable capability values and settable options for each parameter.

FIG. 6 is an explanatory diagram illustrating examples of respondable values for each processing parameter.

FIG. 7 is a flowchart illustrating an example of a procedure of a parameter execution process.

FIG. 8 is a flowchart illustrating an example of a procedure of an integration process.

FIG. 9 is an explanatory diagram illustrating an example of a print setting screen.

FIG. 10 is an explanatory diagram illustrating an example of a print setting screen while options for a color mode are being displayed.

FIG. 11 is a flowchart illustrating an example of a procedure of a response capability determination process.

### DESCRIPTION

Hereinafter, a first embodiment of a printer according to aspects of the present disclosure will be described in detail with reference to the accompanying drawings. In this specification, a multifunction peripheral (hereinafter referred to as an “MFP”) having a printing function and a communication function is disclosed.

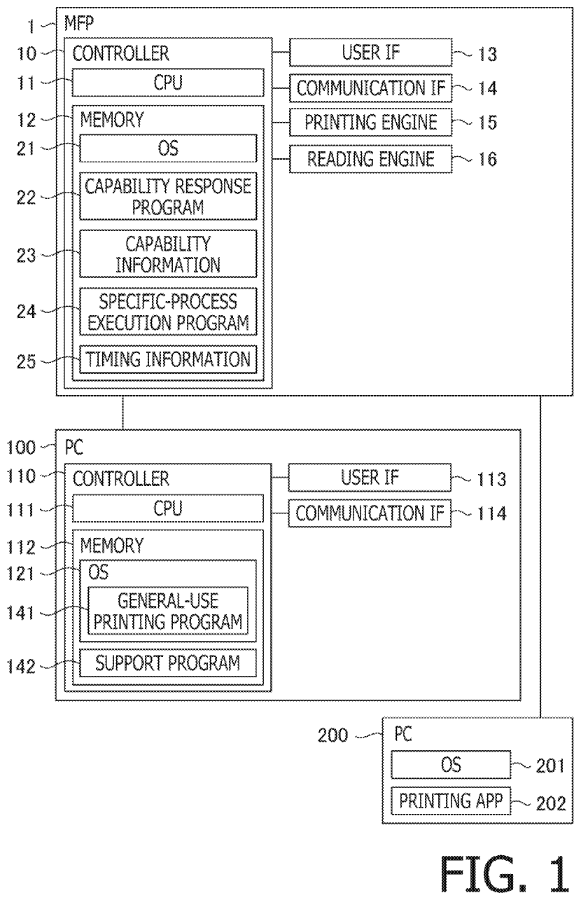

For example, as illustrated in FIG. 1, an MFP 1 of the present embodiment includes a controller 10 including a CPU 11 and a memory 12. The MFP 1 further includes a user interface (hereinafter referred to as a “user IF”) 13, a communication interface (hereinafter referred to as a “communication IF”) 14, a printing engine 15, and a reading engine 16, and these are electrically connected to the controller 10. The MFP 1 is one example of a printer. Note that the controller 10 in FIG. 1 is a generic term collectively referring to hardware and software used for control of the MFP 1, and does not necessarily represent a single piece of hardware actually present in the MFP 1.

The CPU 11 of the MFP 1 executes various types of processes in accordance with a program read from the memory 12 and based on an operation by a user. The memory 12 of the MFP 1 stores various programs and various types of data including an operating system (hereinafter referred to as an “OS”) 21, a capability response program 22, capability information 23, a specific-process execution program 24, and timing information 25. The memory 12 is also used as a work area when various types of processes are executed. A buffer included in the CPU 11 is also one example of the memory 12. Details of the programs and the data will be described later.

One example of the memory 12 is not limited to a ROM, a RAM, and an HDD that are built in the MFP 1, and may be a storage medium that is readable and writable by the CPU 11. For example, an external memory such as a USB memory or an HDD connected to the MFP 1, and a memory or an HDD included in a device connected to the MFP 1 via the communication IF 14, are also examples of the memory 12.

A computer-readable storage medium is a non-transitory medium. In addition to the above examples, the non-transitory medium includes a recording medium such as a CD-ROM and a DVD-ROM. The non-transitory medium is also a tangible medium. In contrast, an electrical signal that transmits a program downloaded from a server on the Internet or the like is a computer-readable signal medium (which is a type of a computer-readable medium), but is not included in the non-transitory computer-readable storage medium.

The user IF 13 includes, for example, a touchscreen panel. The touchscreen panel includes hardware that displays a screen for notifying a user of information and hardware that receives an operation by the user. The user IF 13 may include a combination of a display and a hardware button or the like.

The communication IF 14 includes hardware for communicating with an external device. The communication IF 14 includes a function that supports communication standards such as Wi-Fi®, Ethernet®, and USB. The MFP 1 of the present embodiment can communicate with various IPP clients in accordance with IPP (Internet Printing Protocol) via the communication IF 14. Note that the MFP 1 may include a plurality of communication IFs 14 corresponding to a plurality of communication standards. The MFP 1 may be capable of communication in accordance with a standard other than IPP.

The printing engine 15 includes a configuration for printing an image on a print medium such as a sheet. An image forming method of the printing engine 15 is, for example, an electrophotographic method or an inkjet method. The MFP 1 of the present embodiment may include the printing engine 15 that is capable of executing color printing using a plurality of colorants, or may include the printing engine 15 that performs only monochrome printing using a single colorant.

The reading engine 16 includes a configuration for scanning a document placed on a flatbed or a document placed on a document feeder and conveyed to a reading position, thereby generating scan data as a scan result. The MFP 1 of the present embodiment may include the reading engine 16 that is capable of executing color reading for reading the document as a color image, or may include the reading engine 16 that is capable of executing only monochrome reading for reading the document as a monochrome image.

The MFP 1 of the present embodiment is capable of supporting a print job from an external device that does not use a proprietary printer driver, i.e., so-called driverless printing. Various external devices can transmit a print job to the MFP 1 by communication in accordance with IPP using, for example, a client program that supports an IPP Class Driver, AirPrint, Mopria, or IPP Everywhere. The MFP 1 is capable of communicating with various external devices via the communication IF 14 by communication in accordance with IPP, and is capable of executing printing based on a print job received from the various external devices.

Specifically, as illustrated in FIG. 1, the MFP 1 of the present embodiment is capable of being connected to a personal computer (hereinafter referred to as a “PC”) 100 and a PC 200. The PC 100 and the PC 200 are devices each capable of transmitting a print job to the MFP 1 in accordance with IPP, and each is an example of an IPP client. The MFP 1 can cause the printing engine 15 to perform printing based on a received print job, regardless of whether the print job is received from the PC 100 or from the PC 200.

As illustrated in FIG. 1, the PC 100 includes a controller 110 including a CPU 111 and a memory 112, a user IF 113, and a communication IF 114. In the memory 112 of the PC 100, Windows® is implemented as an OS 121. The OS 121 includes a general-use printing program 141. The OS 121 may be considered to have the OS standard general-use printing program 141. In other words, the general-use printing program 141 may be said to be implemented in the OS 121. The PC 100 is an example of a first type of IPP client. The OS 121 is an example of a particular operating system.

The general-use printing program 141 is an OS-standard program prepared by a vendor of the OS 121 and provided as a part of the OS 121. The general-use printing program 141 is a printing program that is preinstalled in the OS 121, and is, for example, a printing program packaged with the OS 121 and installed on the PC 100 together with the OS 121. One example of the general-use printing program 141 is an IPP Class Driver provided by Microsoft®. Note that the general-use printing program 141 is not configured to use a printer-specific printer driver.

The PC 100 further includes a support program 142, which is a program corresponding to the MFP 1. The support program 142 is a program or a group of programs that cooperates with the general-use printing program 141 and, accompanying processes of the general-use printing program 141, executes processes based on an instruction from the OS 121. The support program 142 is, for example, an application program provided by a vendor of the MFP 1, and is a program that supports control of the MFP 1. The support program 142 is an example of a print support program.

For example, when the OS 121 of the PC 100 receives an instruction to add a new printer to the PC 100, the OS 121 can download an appropriate support program from a server of a vendor of the added printer or from storage designated by the OS 121, in accordance with a type and a model of the added printer, and incorporate the support program into the PC 100. For example, when the MFP 1 is added to the PC 100, the OS 121 incorporates the support program 142 into the PC 100, and stores identification information of the incorporated support program 142 in the memory 112 in association with information indicating the MFP 1.

The general-use printing program 141 activates the support program 142 corresponding to the MFP 1 when, for example, the MFP 1 is selected as a device to perform printing, when a detailed print setting instruction is received while the MFP 1 is selected, or when an instruction to cause the MFP 1 to perform printing is received. The general-use printing program 141 can obtain various types of information from the MFP 1 via the OS 121 by communication in accordance with IPP. For example, in response to a request from the support program 142, the general-use printing program 141 can transmit, to the MFP 1, a command requesting capability information, and can provide the support program 142 with the capability information obtained from the MFP 1.

The capability information includes information of set values that can be set as print settings when printing is performed by the MFP 1. The capability information may include, for example, information indicating presence or absence of a color printing function, information regarding a number of sheet feeding trays and sheets stored in the sheet feeding trays, and information indicating selectable print qualities. The support program 142 can use the capability information obtained from the MFP 1 for processes for printing.

On the other hand, the PC 200 includes an OS 201 other than Windows®. The OS 201 is, for example, macOS®, Linux®, iOS®, or Android®. The OS 201 of the PC 200 does not include a program corresponding to the general-use printing program 141. The PC 200 also does not have a support program that executes processes in cooperation with a general-use printing program. The PC 200 is an example of a second type of IPP client.

The PC 200 includes a printing application program for printing (hereinafter referred to as a “printing app”) 202 that is different from the general-use printing program 141 and the support program 142 of the PC 100. The printing app 202 can transmit a print job to the MFP 1 by communication in accordance with IPP. Examples of the printing app 202 include AirPrint, Mopria, and IPP Everywhere.

The printing app 202 of the PC 200 is capable of obtaining various types of information from the MFP 1 by communication in accordance with IPP via the OS 201 of the PC 200. For example, the printing app 202 is capable of transmitting, to the MFP 1, a command requesting the capability information, obtaining the capability information from the MFP 1, and using the capability information for processes for printing. The printing app 202 is a program that is adaptable to various printing apparatuses and is not a program prepared for the MFP 1.

In communication in accordance with IPP, a command for requesting a capability from the MFP 1 is, for example, a capability request command defined by IPP, namely a “get-printer-attributes” command. The “get-printer-attributes” command is one example of a specific command. The capability request command is capable of including various parameters. Each parameter included in the capability request command is, for example, information that specifies content to be returned as the capability information.

The PC 100 and the PC 200 transmit, as needed, the capability request command and the parameters thereof to the MFP 1 in accordance with IPP. The MFP 1 generates the capability information including a capability value corresponding to each parameter included in the command, and replies to a transmission source as a response to the capability request command. The MFP 1 is capable of replying with the capability information by communication in accordance with IPP, regardless of whether a request is received from the PC 100 or the PC 200.

In IPP, a plurality of types of parameters, which can be included in the capability request command, are defined as standard parameters. Hereinafter, a standard parameter defined in IPP is referred to as a “defined parameter.” Further, in IPP, a value, which can be returned for each defined parameter, is predetermined. Hereinafter, a capability value defined in IPP as a capability that can be returned corresponding to a defined parameter is referred to as a “defined capability value.”

For example, a defined parameter requesting the capability information relating to a color mode function of the MFP 1 is “print-color-mode-supported,” and defined capability values for this parameter are three values indicating “auto,” “color,” and “monochrome.” This parameter is used to request the MFP 1 to respond with, in the capability information, a capability value indicating whether the MFP 1 has a color printing function. By transmitting the capability request command including the defined parameter and obtaining the capability information as a response, the PC 100 and the PC 200 are capable of determining options of a color mode setting that can be accepted as print settings for printing with the MFP 1.

For example, when the MFP 1 receives the capability request command including the above parameter, the MFP 1 replies with a capability value including information indicating “color” when the MFP 1 is capable of executing color printing, information indicating “monochrome” when the MFP 1 is capable of executing monochrome printing, and information indicating “auto” when the MFP 1 has a function of determining whether an image to be printed includes color and printing the image based on a result of the determination. For example, when the MFP 1 is a device that is capable of executing both color printing and monochrome printing and has the function of determining whether the image to be printed includes color, the MFP 1 replies with the capability information including these three types of capability values. When the PC 100 or the PC 200 receives the capability information, the PC 100 or the PC 200 becomes capable of accepting selection, as a color mode in the print settings, from three options: auto, color, and monochrome. Note that an MFP that is capable of executing monochrome printing is often also capable of executing grayscale printing. Therefore, an IPP client that receives a capability value including information indicating “monochrome” may display a grayscale option in addition to a monochrome option.

Further, for example, the MFP 1 that is not capable of executing color printing replies with the capability information including only one capability value indicating “monochrome” as a defined capability value corresponding to the “print-color-mode-supported” parameter. When the PC 100 or the PC 200 receives the capability information, the PC 100 or the PC 200 becomes capable of accepting monochrome and grayscale as the color mode in the print settings. The PC 100 or the PC 200 may become capable of accepting only monochrome as the color mode in the print settings.

The MFP 1 may have, as a capability relating to a color mode, a capability that is not included in the defined capability values. For example, due to expansion of a function by a firmware update or the like, the MFP 1 may come to have a capability that is not included in the defined capability values. For example, the MFP 1 may have a capability of executing, in color printing, color printing adjusted to a natural tone, color printing adjusted to a vivid tone, and color printing using colors that are set so as to be numerically linear without adjustment.

However, because the defined capability values for the defined parameter relating to a color mode do not include capability values indicating these various types of color printing, the MFP 1 is not capable of replying with those capability values as defined capability values in response to the capability request command. Accordingly, a vendor of the MFP 1 made it possible for the MFP 1 to reply with a capability value for a capability that is not included in the defined capability values by transmitting a capability request command including a parameter different from the defined parameter. Hereinafter, a parameter that is not a defined parameter of IPP is referred to as a “proprietary parameter.” Further, a capability value that is not a defined capability value is referred to as a “proprietary capability value.” The MFP 1 of the present embodiment is capable of replying, to a capability request command including a proprietary parameter, with capability information including a proprietary capability value.

Further, a client program supporting the above-described IPP Class Driver, AirPrint, Mopria, IPP Everywhere, and the like are general-use printing programs that support various types of existing printers and are not a program unique to a printer of a particular vendor. Therefore, various general-use printing programs such as the general-use printing program 141 of the PC 100 do not support the proprietary parameter or the proprietary capability value. Accordingly, a vendor of a printer having a proprietary capability, such as the MFP 1, developed, as a program supporting the proprietary parameter and the proprietary capability value, for example, the support program 142 described above.

Next, an operation of the MFP 1 will be described. The processes described below basically indicate processes performed by a CPU in accordance with instructions described in a program. That is, processes such as “determining,” “extracting,” “selecting,” “calculating,” “deciding,” “identifying,” “obtaining,” “receiving,” and “controlling” in the following description represent processes of the CPU. The processes performed by the CPU also include hardware control using an API of an OS. In this specification, an operation of each program will be described while omitting description of the OS. That is, in the following description, a statement to the effect that “program B controls hardware C” may refer to “program B controls hardware C using the API of the OS.” Further, processes performed by a CPU in accordance with instructions described in a program may be described using abbreviated wording. For example, it may be described as “performed by the CPU.” Also, processes performed by a CPU in accordance with instructions described in a program may be described using wording that omits the CPU, such as “performed by program A.”

In this specification, terms such as “notification,” “informing,” “notice,” “reply,” “response,” “answer,” and the like are used not only in the sense of conveying information to a person, but also as terms meaning communication or exchange of information between devices or between components in a device. Note that components in a device include software.

The term “obtain” is used as a concept that does not necessarily require a request. That is, processes in which a CPU receives data without making a request are also included in the concept of “the CPU obtains data.” Also, “data” in this specification is represented by a computer-readable bit string. Data having the same substantial meaning but different formats is to be treated as the same data. The same applies to “information” in this specification. Further, “requesting” and “instructing” are concepts indicating outputting, to a counterpart, information indicating a request or information indicating an instruction. Information indicating a request or information indicating an instruction may also be simply referred to as a “request” or an “instruction.”

Processes by the CPU to determine whether information A indicates matter B may be conceptually described, for example, as “determining from information A whether matter B applies.” Processes by the CPU to determine whether information A indicates matter B or indicates matter C may be conceptually described, for example, as “determining from information A whether matter B or matter C.”

In this specification, a setting item may be simply referred to as a “setting.” A setting value may also be simply referred to as a “setting.” Note that a setting value may be referred to as a “parameter.” Further, storing a setting value in a memory or the like may be simply referred to as “setting.” Also, an operation for setting and an input for setting may be simply referred to as “setting.”

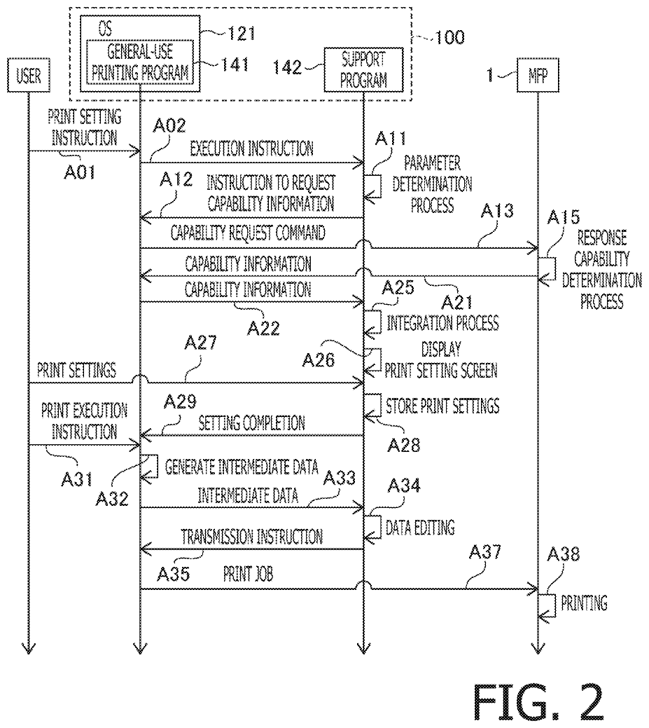

A procedure for causing the MFP 1 to execute printing using the PC 100 will be described with reference to the sequence diagram of FIG. 2. Note that various programs incorporated in the PC 100, such as an application program that generates or edits a document or an image, activate the general-use printing program 141 when use of a printing function is selected. Also, when the user using the PC 100 wishes to cause the MFP 1 to execute printing, the user selects the MFP 1 as a device to execute printing.

When the MFP 1 is selected at startup or when an instruction to change a device to be used for printing to the MFP 1 is received, the general-use printing program 141 activates the support program 142 corresponding to the MFP 1. Further, for example, when the general-use printing program 141 receives an instruction to start detailed print settings (A01), the general-use printing program 141 passes to the support program 142 an execution instruction including an instruction to accept print settings (A02).

The support program 142 is capable of obtaining the capability information of the MFP 1, for example, when the support program 142 receives a startup instruction, when providing of information is requested by the general-use printing program 141, or when information indicating that an instruction to perform detailed print settings has been received is transmitted. For example, by instructing the general-use printing program 141, the support program 142 causes the general-use printing program 141 to transmit a capability request command to the MFP 1, and the support program 142 obtains a capability value from the MFP 1 via the general-use printing program 141.

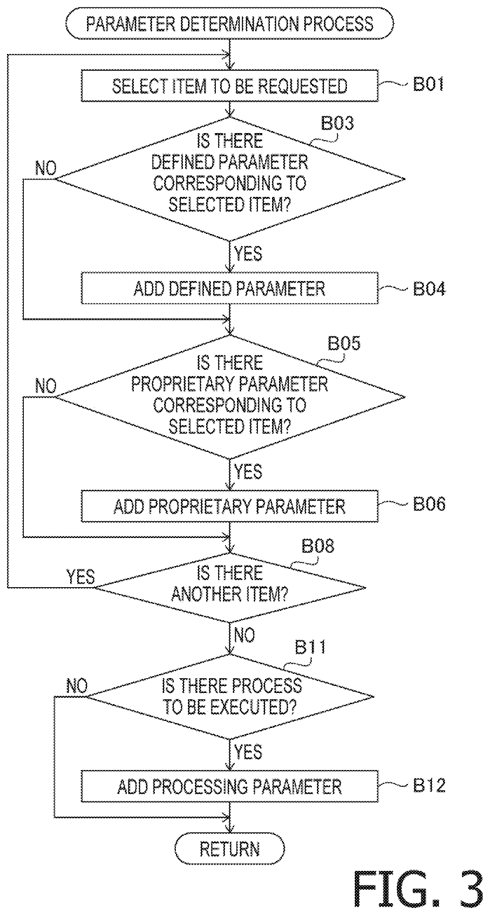

When the support program 142 obtains the capability information of the MFP 1 in response to the instruction of A02, the support program 142 executes a parameter determination process for determining parameters to be included in the capability request command (A11). A procedure of the parameter determination process will be described with reference to the flowchart of FIG. 3. The parameter determination process is executed by the CPU 111 of the PC 100 in accordance with the support program 142.

In the parameter determination process, the CPU 111 selects one item indicating a capability to be requested (B01). Since there are many types of parameters that can be included in the capability request command, the support program 142 is capable of requesting only capabilities needed at that time. The support program 142 may not request information already possessed and information unlikely to change in a short period, such as the model information of the MFP 1 or information indicating a communication mode with the MFP 1, if such information has already been obtained.

The CPU 111 determines whether there is a defined parameter corresponding to an item selected in B01 (B03). When the CPU 111 determines that the defined parameter is present (B03: YES), the CPU 111 adds the defined parameter to parameters to be included in the capability request command (B04). Note that the support program 142 may have, in advance, information regarding various parameters that can be included in the capability request command, or may obtain the information from a server or the like provided by the general-use printing program 141 or a vendor of the MFP 1.

For example, the defined parameters defined in IPP include “document-format-supported” requesting information indicating supported file formats, “compression-supported” requesting information indicating supported compression formats, “media-ready” requesting information indicating a default print medium, “print-color-mode-supported” requesting information indicating supported color modes, and “print-quality-supported” requesting information indicating types of supported print qualities. For example, when an item selected in B01 is an item indicating a color mode, the CPU 111 adds “print-color-mode-supported” in B04.

After B04, or when the CPU 111 determines that the defined parameter is absent (B03: NO), the CPU 111 determines whether there is a proprietary parameter corresponding to an item selected in B01 (B05). The proprietary parameter is a parameter for requesting a proprietary capability value as a capability value relating to each item, and is a parameter that both the MFP 1 and the support program 142 are capable of supporting.

For example, when the CPU 111 determines that an item selected in B01 is a color mode and that a proprietary parameter “vendor-custom-print-color-mode-supported” corresponding to the color mode is present, the CPU 111 adds the proprietary parameter in B06. The proprietary parameter is a parameter for requesting, as a capability relating to a color mode, a proprietary capability value that is a capability value other than the defined capability value. Specifically, the proprietary parameter is a parameter for requesting a capability value indicating whether the MFP 1 has each capability of “custom_normal,” “custom_vivid,” and “custom_none.” Through B04 and B06, both a defined parameter and a proprietary parameter are added as parameters for requesting capability values relating to the color mode.

Note that, among proprietary parameters included in the support program 142, some have corresponding defined parameters and some do not. Examples of the proprietary parameter include “vendor-custom-density-supported” and “vendor-custom-contrast-supported” requesting capability values indicating ranges that can be set for a density and a contrast, “vendor-custom-toner-save-supported” requesting a capability value indicating presence or absence of a toner save mode, and “vendor-custom-print-quality-supported” requesting capability values other than defined capability values as a print quality. Among these four types of parameters, a proprietary parameter indicating a print quality has a corresponding defined parameter, whereas the other three do not have corresponding defined parameters.

When the CPU 111 determines that the proprietary parameter corresponding to the selected item is present (B05: YES), the CPU 111 adds the proprietary parameter to parameters to be included in the capability request command (B06). When there is a defined parameter corresponding to the selected item, both the defined parameter and the proprietary parameter are added.

After B06, or when the CPU 111 determines that the proprietary parameter is absent (B05: NO), the CPU 111 determines whether there is another item for which a capability value is to be requested (B08). When the CPU 111 determines that there is another item (B08: YES), the CPU 111 proceeds to B01, selects the next item, and adds a parameter corresponding to the selected item.

When the CPU 111 determines that there is no other item for which a capability value is to be requested (B08: NO), the CPU 111 determines whether there is a process to be executed by the MFP 1 (B11). Examples of the process to be executed by the MFP 1 include test printing, a preparatory operation of the printing engine 15, and color calibration of the printing engine 15. The CPU 111 determines whether to cause various types of processes to be executed, for example, in accordance with an elapsed time from a previous execution instruction, the number of print sheets for which execution instructions have been issued, a change of a colorant or a print medium, and a change in a surrounding environment.

When the CPU 111 determines that there is a process to be executed by the MFP 1 (B11: YES), the CPU 111 adds, to the parameters to be included in the capability request command, a processing parameter indicating an instruction to execute the process (B12). After B12, the CPU 111 ends the parameter determination process. Examples of the processing parameter include “vendor-custom-exec-testprint” indicating an instruction to execute test printing, “vendor-custom-exec-engine-pre-start” indicating an instruction to start a preparatory operation of the printing engine 15, and “vendor-custom-exec-calibration” indicating an instruction to execute color calibration. When the CPU 111 causes the MFP 1 to execute a plurality of types of processes, the CPU 111 may add a plurality of processing parameters.

Note that the PC 100 may be capable of receiving, based on a user operation via the user IF 113, designation of a process to be executed by the MFP 1. In that case, the CPU 111 may receive the designation by the user instead of making the determination in B11. Then, in B12, the CPU 111 may add, to the parameters to be included in the capability request command, a processing parameter indicating an instruction to execute the process designated by the user.

Each processing parameter is not a defined parameter defined in IPP or a proprietary parameter for requesting a vendor-specific capability value, but is a parameter that instructs the MFP 1 to execute specific processing. Each of the defined parameter and the proprietary parameter is an example of a capability parameter. The processing parameter is a parameter that specifies a process. When adding a processing parameter, the CPU 111 adds the processing parameter to a capability request command in a format defined by an IPP standard. By conforming to the IPP standard, when the MFP 1 receives the capability request command, the MFP 1 can readily identify each parameter.

By this parameter determination process, the support program 142 corresponding to the MFP 1 of the present embodiment can add, as parameters to be included in the capability request command, the proprietary parameter that differs from the defined parameter and requests the proprietary capability value indicating the capability specific to the MFP 1, and the processing parameter that instructs execution of a specific process. The support program 142 can also instruct the general-use printing program 141 such that the capability request command including the parameters determined in the parameter determination process is transmitted to the MFP 1. A capability request command including the parameters determined in the parameter determination process is an example of a specific command.

Note that, among defined parameters defined in IPP, there is a parameter that collectively requests information of a plurality of items. When requesting information of the plurality of items, the CPU 111 may add, in B04, a parameter that collectively requests information of the plurality of items instead of adding a parameter for each item.

For example, the CPU 111 may add “all,” which collectively requests all defined capability values that the MFP 1 has, and may add “printer-description” or “job-template,” each of which is a parameter that specifies a particular group and collectively requests a plurality of defined capability values included in the specified group. The “all” parameter has the same meaning as enumerating all defined parameters. Further, “printer-description” is a parameter that collectively requests, for example, “document-format-supported,” “compression-supported,” and “media-ready.” “job-template” is a parameter that collectively requests, for example, “print-color-mode-supported” and “print-quality-supported.”

A parameter that collectively requests information of the plurality of items, such as “all,” is included among the defined parameters. Since a general-use printing program (including the general-use printing program 141, and the above-described general-use printing programs corresponding to an IPP Class Driver, AirPrint, Mopria, and IPP Everywhere) is capable of transmitting the capability request command including various defined parameters, the general-use printing program is capable of transmitting a capability request command including a parameter that collectively requests information of a plurality of items.

Returning to the description of the printing procedure illustrated in the sequence diagram of FIG. 2, after the support program 142 ends the parameter determination process in A11, the support program 142 provides the general-use printing program 141 with a capability request command including the determined parameters and instructs transmission of the capability request command to the MFP 1 (A12). Accordingly, the general-use printing program 141 transmits the capability request command and the parameters thereof to the MFP 1 in accordance with IPP, in response to the instruction from the support program 142 (A13).

Upon receiving the capability request command transmitted in A13, the MFP 1 generates capability information indicating capability values of the MFP 1 to be returned, based on each parameter included in the capability request command. For this purpose, the MFP 1 executes a response capability determination process (A15).

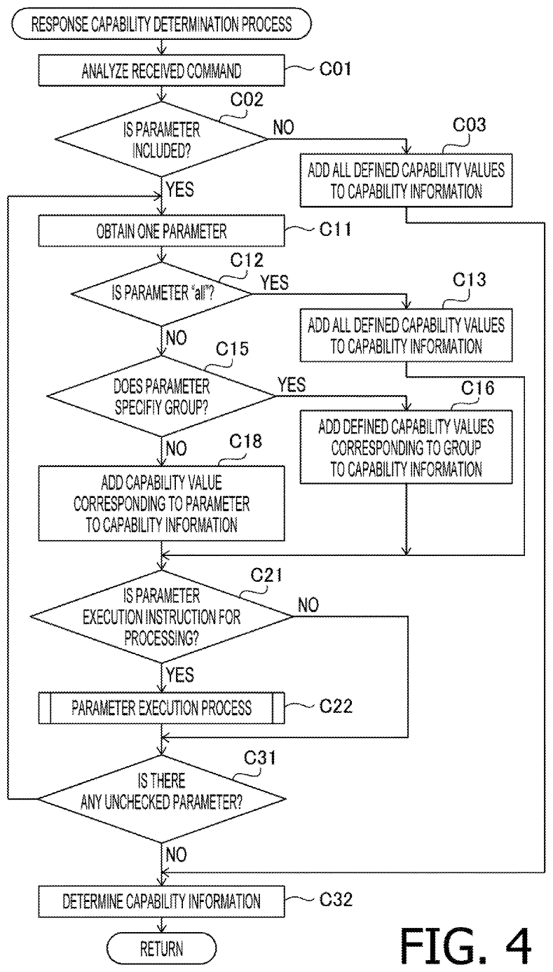

A procedure of the response capability determination process will be described with reference to the flowchart of FIG. 4. The response capability determination process is executed by the CPU 11 of the MFP 1 in accordance with the capability response program 22 of the MFP 1 (see FIG. 1). At start of this capability response process, the CPU 11 prepares capability information including no information as response information.

In the response capability determination process, the CPU 11 analyzes the received capability request command (C01). The CPU 11 then determines whether the received capability request command includes a parameter (C02). When the CPU 11 determines that the capability request command does not include a parameter (C02: NO), the CPU 11 adds, for example, all defined capability values to the capability information based on the capability information 23 stored in the memory 12 (see FIG. 1) (C03). The capability request command that includes no parameter has the same meaning as a command including only “all” of the defined parameter as a parameter.

When the CPU 11 determines that the capability request command includes a parameter (C02: YES), the CPU 11 sequentially checks each parameter included in the command. The CPU 11 obtains one parameter to be checked (C11), and determines whether the obtained parameter is “all” (C12). When the CPU 11 determines that the parameter is “all” (C12: YES), the CPU 11 adds all defined capability values to the capability information (C13). Note that the CPU 11 does not add a proprietary capability value in response to the “all” parameter.

When the CPU 11 determines that the parameter to be checked is not “all” (C12: NO), the CPU 11 determines whether the parameter is the parameter specifying the group (C15). When the CPU 11 determines that the parameter is the parameter specifying the group (C15: YES), the CPU 11 adds, to the capability information to be returned, defined capability values corresponding to all defined parameters included in the specified group (C16). The CPU 11 does not add a proprietary capability value in response to the parameter specifying the group.

When the CPU 11 determines that the parameter is not the parameter specifying the group (C15: NO), the CPU 11 adds, to the capability information, a capability value corresponding to the obtained parameter to be checked (C18). For example, when the capability request command includes a parameter specifying a print setting item, the CPU 11 adds, to the capability information, information indicating options that can be set for the print setting item and/or a range of settable setting values.

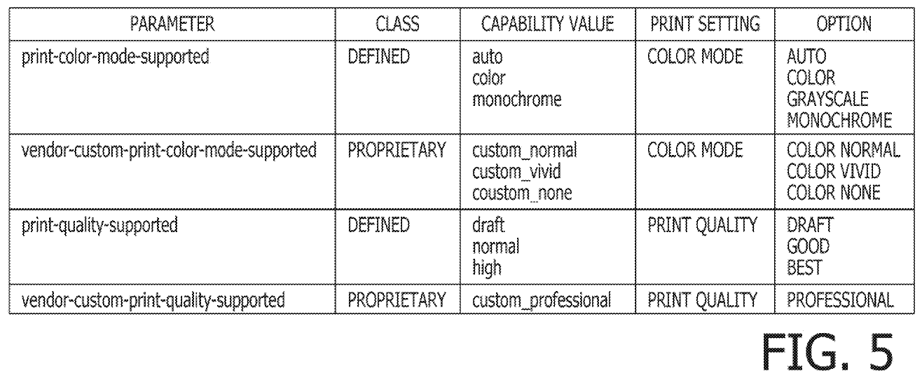

In C18, when the parameter to be checked is the defined parameter, the CPU 11 adds a defined capability value, and when the parameter to be checked is the proprietary parameter, the CPU 11 adds a proprietary capability value. For example, as illustrated in FIG. 5, the CPU 11 has, in advance, information indicating capability values that can be returned for each parameter included in the received capability request command.

For example, when the parameter to be checked is “print-color-mode-supported,” which is the defined parameter, the CPU 11 adds information indicating supported capability values among defined capability values “auto,” “color,” and “monochrome” to the capability information. Since the MFP 1 of the present embodiment is capable of supporting all three types for the color mode, the CPU 11 adds all defined capability values to the capability information.

Further, for example, when the parameter to be checked is “vendor-custom-print-color-mode-supported,” which is a proprietary parameter, the CPU 11 adds, to the capability information, information indicating supported capability values among proprietary capability values “custom_normal,” “custom_vivid,” and “custom_none.” Since the MFP 1 of the present embodiment is capable of supporting all three types for the color mode, the CPU 11 adds all proprietary capability values to the capability information.

After C13, C16, or C18, the CPU 11 determines whether the parameter obtained in C11 is a parameter that instructs execution of a process (C21). When the CPU 11 determines that the parameter is a parameter that instructs execution of the process (C21: YES), the CPU 11 executes the parameter execution process (C22). The parameter execution process is executed by the CPU 11 of the MFP 1 based on the specific-process execution program 24 (see FIG. 1).

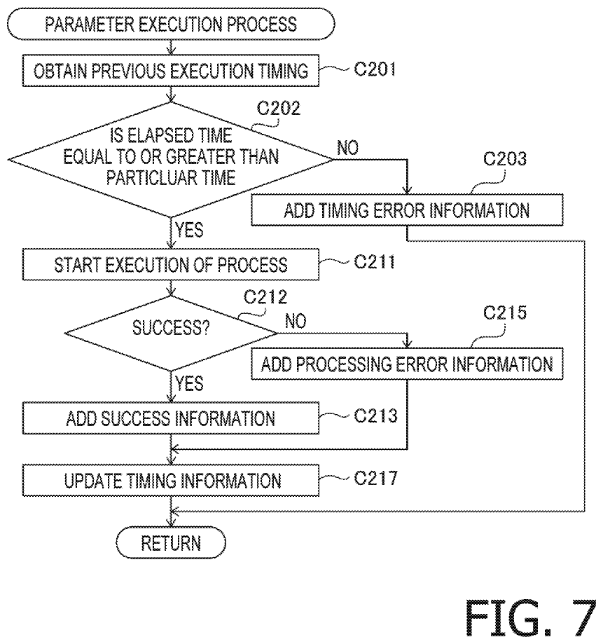

A procedure of the parameter execution process will be described with reference to the flowchart of FIG. 7. In the parameter execution process, the CPU 11 obtains, from the timing information 25 in the memory 12 (see FIG. 1), information indicating a previous execution timing corresponding to the instructed process (C201). When the MFP 1 executes the process to be executed based on the received capability request command, the MFP 1 stores, as will be described later, information indicating an execution date and time as the timing information 25 in association with information of the executed process.

Based on the timing information 25 and information indicating a current date and time, the CPU 11 determines whether an elapsed time since the previous execution is equal to or greater than a particular time (C202). When the CPU 11 determines that the particular time has not elapsed since the previous execution (C202: NO), the CPU 11 adds, as result information to the capability information, timing error information indicating a timing error (C203). The timing error information is error information indicating that the particular time has not elapsed since the previous execution. The result information indicating the timing error is, for example, information indicating “time_error.” In this case, the CPU 11 does not execute the instructed process.

For example, when execution of the same process is instructed consecutively within a short period, there is a possibility that the instruction is from a malicious program. The MFP 1 does not execute the instructed process when an elapsed time since the previous execution timing is less than the particular time. Accordingly, execution of inappropriate process due to the malicious program is avoided. Further, by returning information indicating “time_error” in this case, a transmission source of the capability request command can understand a reason why the process was not executed.

When the CPU 11 determines that the elapsed time since the previous execution is equal to or greater than the particular time (C202: YES), the CPU 11 starts execution of the process specified by the processing parameter (C211). The CPU 11 then determines whether execution of the process has succeeded (C212). When the CPU 11 determines that the execution of the process has succeeded (C212: YES), the CPU 11 adds, to the capability information, result information indicating success of the process (C213). The result information indicating success is, for example, information indicating “success.”

The CPU 11 may reply with result information indicating success when the CPU 11 is able to start the process. For example, when the specified process is a preparatory operation of the printing engine 15, it is sufficient that the operation has started, and the CPU 11 does not need to wait for completion of the operation. In this case, the CPU 11 may add, to the capability information, the result information indicating success upon starting the operation.

On the other hand, when the CPU 11 determines that the CPU 11 is unable to start the process, or when the CPU 11 determines that an error has occurred during the process (C212: NO), the CPU 11 adds, to the capability information as result information, process error information indicating a process error (C215). The result information indicating the process error is, for example, information indicating “exec_error.” For example, when the CPU 11 receives the capability request command including an instruction for test printing and there is no print sheet and/or no colorant, the CPU 11 determines that the process error has occurred and adds information indicating “exec_error.”

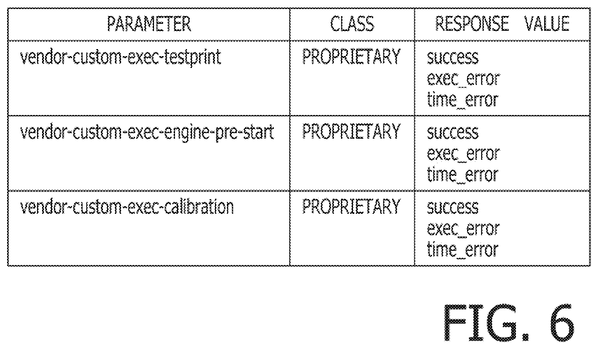

For example, as illustrated in FIG. 6, the CPU 11 has, in advance, information indicating capability values that can be returned as result information for each processing parameter included in the received capability request command. In accordance with determination results in C202 and C212, the CPU 11 adds, to the capability information, result information corresponding to the processing parameter. For each processing parameter, the CPU 11 adds, to the capability information, result information indicating one of “success” as success information, “exec_error” as process error information, and “time_error” as timing error information. The success information and the process error information are information indicating that execution of the process specified by the processing parameter has been received, and are information indicating a processing result of the executed process. Note that the MFP 1 may be capable of replying with different result information depending on a type of the processing parameter.

When the processing parameter included in the capability request command indicates an instruction for test printing, if the process succeeds, a printed matter is discharged and thus a user can recognize the success; therefore, the CPU 11 does not have to add information indicating success. However, when the parameter included in the received capability request command is only the processing parameter indicating test printing, the CPU 11 may reply with the result information even in a case where the process succeeds.

After C213 or C215, the CPU 11 updates the timing information 25 based on the instructed process and a current date and time (C217). The CPU 11 may refrain from updating the timing information 25 in a case of a process error. After C203 or C217, the CPU 11 ends the parameter execution process and returns to the response capability determination process.

Returning to the description of the response capability determination process of FIG. 4, after completion of the parameter execution process in C22, or when the CPU 11 determines that the parameter is not a parameter instructing execution of the process (C21: NO), the CPU 11 determines whether there is any unchecked parameter (C31). When the CPU 11 determines that there is an unchecked parameter (C31: YES), the CPU 11 proceeds to C11 and obtains a next parameter as a parameter to be checked. After C03, or when the CPU 11 determines that all parameters included in the capability request command have been checked (C31: NO), the CPU 11 determines, as information to be returned, the capability information to which capability values have been added (C32), and ends the response capability determination process.

Note that the PC 200 does not include the general-use printing program 141 and the support program 142. The printing app 202 of the PC 200 is a general-use printing program that is not prepared for the MFP 1. Therefore, a general-use printing program such as the printing app 202 does not transmit the capability request command including the proprietary parameter or the processing parameter. The general-use printing program such as the printing app 202 is capable of transmitting, to the MFP 1, the capability request command including the defined parameter and the capability request command including a parameter (such as “all”) that collectively requests a plurality of defined capability values. Accordingly, the MFP 1 does not execute the process in response to a request from the PC 200. Further, the MFP 1 replies, to the PC 200, with the capability information including only defined capability values corresponding to defined parameters.

Further, although the MFP 1 is capable of replying with a proprietary capability value not defined in IPP, the MFP 1 replies with only defined capability values in response to the capability request command including only defined parameters. Further, when the MFP 1 receives the capability request command including a parameter (such as “all”) that collectively requests defined capability values, the MFP 1 replies with only defined capability values regardless of whether the transmission source of the capability request command is the printing app 202, the general-use printing program 141 that is not in cooperation with the support program 142, or the general-use printing program 141 that is in cooperation with the support program 142. For example, even when the general-use printing program 141 of the PC 100 is used but is not in cooperation with the support program 142, the capability request command transmitted from the PC 100 includes no proprietary parameter. In this case, the MFP 1 also replies to the PC 100 with the capability information including only the defined capability value corresponding to defined parameters.

As described above, since the MFP 1 replies with only defined capability values in response to the capability request command including the defined parameter, even when a vendor of the MFP 1 adds a new proprietary capability to the MFP 1 by an update or the like, the vendor does not need to obtain certification again for a standard such as AirPrint, Mopria, or IPP Everywhere.

Returning to the description of the printing procedure illustrated in the sequence diagram of FIG. 2, after the MFP 1 ends the response capability determination process in A15, the MFP 1 transmits, as a response to the received capability request command, the determined capability information to the general-use printing program 141 of the PC 100 that is the transmission source of the capability request command (A21). The MFP 1 replies with the capability information in a format defined by IPP. Since the MFP 1 replies in the format defined by the IPP standard, the MFP 1 can readily reply with a response to the capability request command. By replying in the format defined by IPP, the PC 100 can readily use the capability information including the proprietary capability of the MFP 1.

The general-use printing program 141 provides the capability information obtained from the MFP 1 to the support program 142 (A22). Accordingly, the support program 142 can obtain the capability information of the MFP 1. Note that the general-use printing program 141 typically does not perform analysis or the like of the returned capability information, and provides the capability information to the support program 142 as-is.

As described above, the support program 142 can generate the capability request command including the defined parameter, the proprietary parameter, and the processing parameter, and can cause the capability request command to be transmitted to the MFP 1. When the MFP 1 receives the capability request command including the processing parameter, the MFP 1 executes the instructed process and replies with result information indicating an execution result of the instructed process. Further, when the MFP 1 receives the capability request command including the defined parameter and the proprietary parameter, the MFP 1 replies with the capability information including the defined capability value corresponding to the defined parameter and the proprietary capability value corresponding to the proprietary parameter. Accordingly, the support program 142 can cause the MFP 1 to execute a process specific to the MFP 1. Further, the support program 142 can obtain not only the defined capability values of the MFP 1 but also the proprietary capability values of the MFP 1 that are not defined in IPP.

Instead of causing the general-use printing program 141 to transmit one capability request command including the defined parameter, the proprietary parameter, and the processing parameter, the support program 142 may cause the general-use printing program 141 to separately transmit the capability request command including the defined parameter, the capability request command including the proprietary parameter, and the capability request command including the processing parameter. In that case, the MFP 1 replies with the defined capability values to the capability request command including the defined parameter, and replies with the proprietary capability values to the capability request command including the proprietary parameter. Further, the MFP 1 replies with result information indicating a result of the process to the capability request command including the processing parameter. The support program 142 can obtain the defined capability values and the proprietary capability values, and can also obtain information regarding the process result of the instructed process, by obtaining the various responses to the respective commands.

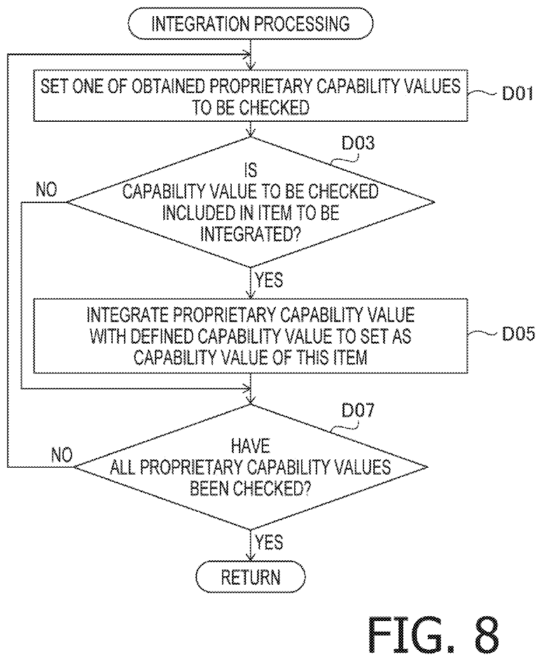

Based on the obtained capability information, the support program 142 executes an integration process (A25) for integrating the defined capability values and the proprietary capability values and determining a set of options that can be received as print settings. A procedure of the integration process will be described with reference to the flowchart of FIG. 8.

In the integration process, the CPU 111 sets one of the proprietary capability values included in the obtained capability information as a capability value to be checked (D01). The CPU 111 then determines whether the capability value to be checked is a capability value included in the item to be integrated (D03). For example, the above-described proprietary capability values of the color mode are capability values relating to the same item as the defined capability values of the color mode, and are capability values to be integrated. Further, the capability value indicating a print quality is also the capability value to be integrated. On the other hand, capability values indicating a settable range of a density and a contrast and a capability value indicating presence or absence of a toner save mode are not capability values to be integrated because there is no item corresponding to such capability values among the defined capability values.

When the CPU 111 determines that the capability value to be checked is the capability value to be integrated (D03: YES), the CPU 111 integrates the proprietary capability value to be checked with the defined capability value of the same item to obtain the capability value for one item (D05). For example, the support program 142 integrates the proprietary capability values of the color mode with the defined capability values of the color mode to obtain the capability value of the color mode.

After D05, or when the CPU 111 determines that the capability value to be checked is not the capability value to be integrated (D03: NO), the CPU 111 determines whether all of the proprietary capability values have been checked (D07). When the CPU 111 determines that there is an unchecked proprietary capability value (D07: NO), the CPU 111 proceeds to D01 and checks the next proprietary capability value. When the CPU 111 determines that all of the proprietary capability values have been checked (D07: YES), the CPU 111 ends the integration process.

In the response capability determination process (see FIG. 4), in a case where the parameter included in the capability request command is the defined parameter, only the defined capability value is added to the capability information, and in a case where the parameter included in the capability request command is the proprietary parameter, only the proprietary capability value is added to the capability information. However, the MFP 1 may be configured such that, when the MFP 1 receives the capability request command including the proprietary parameter, the MFP 1 adds, to the capability information, the corresponding defined capability value and the proprietary capability value even when the corresponding defined parameter is not included. Even in this case, the MFP 1 can reply with the proprietary capability value in response to the capability request command including the proprietary parameter.

When the capability request command including the defined parameter and the proprietary parameter for the same item is transmitted to the MFP 1 having this configuration, the support program 142 may obtain the same defined capability value for both parameters. When the support program 142 obtains the capability information redundantly including the same capability value, the support program 142 may, in D05 of the integration process (see FIG. 8), replace the corresponding defined capability value with all capability values returned in response to the proprietary parameter, and treat the resultant as an integrated capability value. The support program 142 may then cause the print setting screen that does not include duplicate options to be displayed based on the integrated capability value. Even in this case, a user can select a setting value based on either the defined capability value or the proprietary capability value.

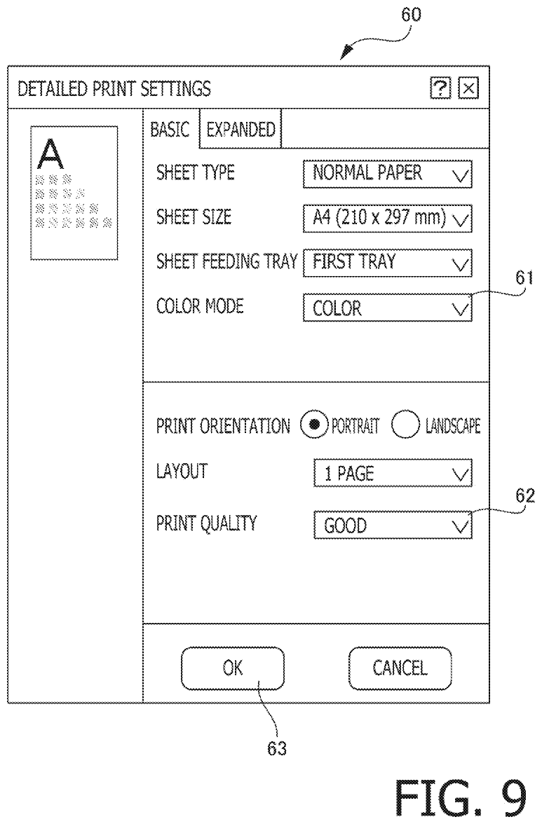

Returning to the description of the printing procedure illustrated in the sequence diagram of FIG. 2, after the integration process in A25 ends, the support program 142 causes a print setting screen for receiving print settings to be displayed on the user IF 113 based on the integrated capability values (A26). For example, as illustrated in FIG. 9, the support program 142 causes a print setting screen 60 that is capable of receiving selection of print setting values for various print setting items to be displayed, and receives a user operation. When the support program 142 obtains the capability information including the proprietary capability values, the support program 142 causes the print setting screen 60 including options indicating print setting values corresponding to the proprietary capability values to be displayed.

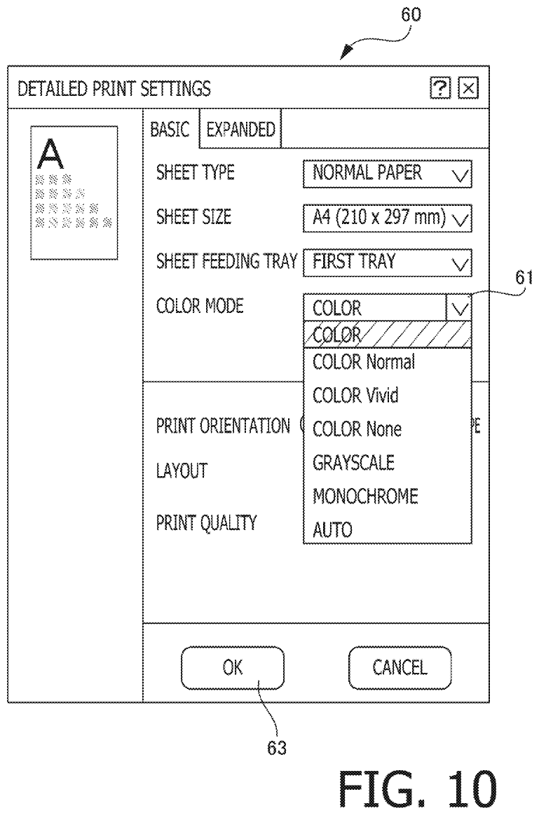

The user can select various print setting values by operating the displayed print setting screen 60 (A27). For example, when the support program 142 receives an operation on a color mode setting item 61, the support program 142 causes a list of options for the color mode to be displayed, as illustrated in FIG. 10, and becomes capable of receiving a user selection.

In accordance with capability values of the MFP 1, options that are selectable as print settings are prepared, for example, as illustrated in FIG. 6. As described above, since the support program 142 has integrated capability values of the color mode, the support program 142 causes options corresponding to defined capability values, Auto, Color, Grayscale, and Monochrome, to be displayed in a selectable manner, and also causes options corresponding to proprietary capability values, Color Normal, Color Vivid, and Color None, to be displayed in a selectable manner.

For example, when the support program 142 receives an operation on a print quality setting item 62, the support program 142 displays options “Good,” “Draft,” and “Best,” which respectively correspond to defined capability values “normal,” “draft,” and “high,” and also displays an option “Professional,” which corresponds to a proprietary capability value “custom_professional.” “Good” is a setting value indicating normal quality, “Draft” is a setting value indicating low quality, and “Best” is a setting value indicating high quality. “Professional” is a setting value indicating a quality higher than “Best.”

By transmitting the capability request command including the defined parameter and the proprietary parameter to the MFP 1 and obtaining the defined capability value and the proprietary capability value of the MFP 1, the support program 142 can display, in a selectable manner, print setting values corresponding to the defined capability values and print setting values corresponding to the proprietary capability values. Accordingly, the user can select the setting value based on either the defined capability values or the proprietary capability values.

When the user has determined all print settings, the user confirms the print setting values by operating the OK button 63 on the print setting screen 60. The support program 142 stores the print setting values selected by the user in the memory 112 (A28). The support program 142 also provides, to the general-use printing program 141, information indicating that the print settings have been completed (A29). Accordingly, the general-use printing program 141 becomes capable of receiving a user instruction such as an instruction to execute printing. The support program 142 may provide the general-use printing program 141 with, among information indicating the determined print setting values, for example, information of the setting value corresponding to the defined capability value.

When the general-use printing program 141 receives the user instruction to execute printing (A31), the general-use printing program 141 generates intermediate data based on image data to be printed (A32). For example, based on the image data to be printed obtained from an application program that creates or edits a document or an image, the general-use printing program 141 can generate the intermediate data and can provide the generated intermediate data to the support program 142 (A33).

For example, the support program 142 obtains the intermediate data from the general-use printing program 141 and edits the intermediate data as needed based on the print setting values stored in the memory 112 in A28 (A34). Then, by providing the edited intermediate data to the general-use printing program 141, the support program 142 instructs generation of print data and transmission of the print data to the MFP 1 (A35).

The general-use printing program 141 and the support program 142 may cooperate to generate print data in a manner different from a manner in which the support program 142 edits the intermediate data generated by the general-use printing program 141. For example, the support program 142 may generate the intermediate data and/or the print data. Further, when the image data to be printed obtained from various application programs is data suitable for generating the print data, the general-use printing program 141 may generate the print data directly from the image data without generating the intermediate data.

Based on the print setting values stored in A28, the support program 142 may transmit a command to the MFP 1 before transmission of a print job. For example, when “Professional” is selected as a print quality, the support program 142 may transmit, to the MFP 1, a command that instructs printing in “Professional.” The support program 142 may transmit the command to the MFP 1, or may provide the command to the general-use printing program 141 and instruct transmission to the MFP 1.

Based on the intermediate data edited by the support program 142, the general-use printing program 141 generates a print job and transmits the generated print job to the MFP 1 (A37). That is, in the print job generated by the general-use printing program 141, print setting values that the support program 142 received from a user designation in A27 and stored in the memory in A28 are specified. When the print setting value corresponding to the proprietary capability value is specified by the user, the support program 142 can cause the MFP 1 to perform printing in accordance with the proprietary capability value. Accordingly, even the PC 100 that does not use a printer driver can use proprietary capabilities that the MFP 1 originally has. The processes in A34 and A35 by the support program 142 is processing for transmitting, to the MFP 1, the print job in which print setting values selected by the user are specified.

The MFP 1 executes printing based on the received print job (A38). In a case where the MFP 1 has received the command associated with the print job, the MFP 1 performs, when printing the print job, an operation based on the received command. Accordingly, a printed matter is printed based on the print setting value selected by a user.

As described above in detail, when the capability request command received from an IPP client such as the PC 100 includes a processing parameter that instructs execution of the process, the MFP 1 of the first embodiment executes the specified process. Accordingly, the PC 100 can cause the MFP 1 to execute the process that serves as the proprietary capability of the MFP 1 by using the capability request command. As a result, even when the PC 100 does not use a printer driver, the PC 100 can instruct execution of the process executable by the MFP 1, and therefore use of the proprietary capability originally provided in the MFP 1 can be expected.

Further, when the capability request command received from an IPP client includes the proprietary parameter, the MFP 1 of the first embodiment replies with capability information including the proprietary capability value of the MFP 1. Further, the support program 142 of the PC 100 can instruct the general-use printing program 141 of the PC 100 such that the capability request command including the proprietary parameter is transmitted to the MFP 1. When the support program 142 obtains, as a response to the capability request command including the proprietary parameter, the capability information including the proprietary capability value of the MFP 1, the support program 142 becomes capable of receiving print settings based on the proprietary capability value of the MFP 1. Accordingly, even for a print job transmitted from the PC 100 that is an IPP client, the proprietary capability originally provided in the MFP 1 can be used.

Next, other embodiment in which a printer is embodied will be described in detail with reference to the accompanying drawings. The MFP 1 of the other embodiment has a configuration similar to that of the MFP 1 of the first embodiment and executes processes that are partly different from the processes executed by the MFP 1 of the first embodiment. Regarding a configuration and a procedure similar to those of the MFP 1 of the first embodiment, the same reference signs as in the first embodiment are used, and description thereof will be omitted.

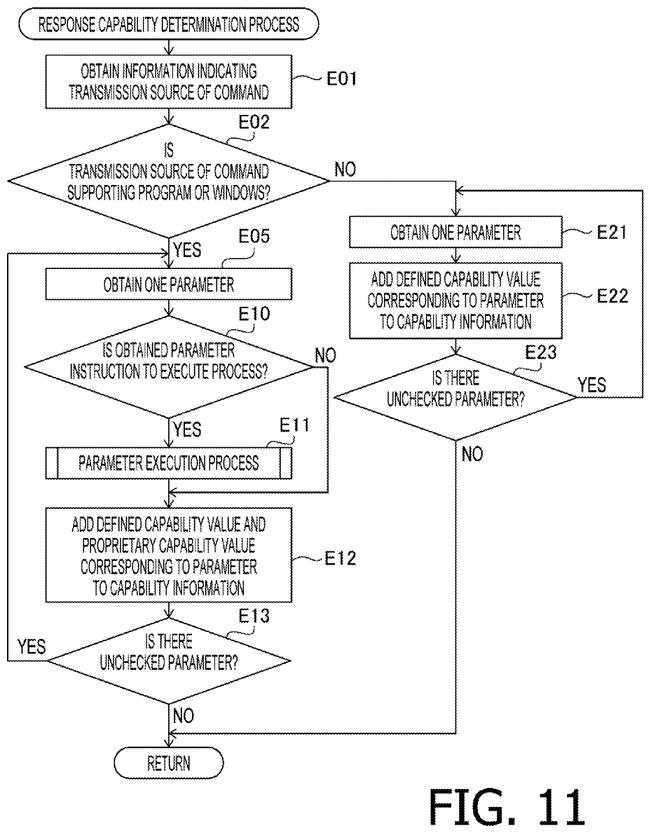

As in the first embodiment, the MFP 1 of the present embodiment is capable of receiving a capability request command from the PC 100 and the PC 200. When the MFP 1 receives a capability request command, the MFP 1 executes the response capability determination process different from the response capability determination process (see FIG. 4) performed by the MFP 1 of the first embodiment. A procedure of the response capability determination process of the present embodiment will be described with reference to the flowchart of FIG. 11. The response capability determination process is executed by the CPU 11 of the MFP 1 in accordance with the capability response program 22 (see FIG. 1) of the MFP 1 of the present embodiment. At the start of the capability response process, the CPU 11 prepares capability information that includes no information as response information.

In the response capability determination process of FIG. 11, the CPU 11 obtains identification information indicating a transmission source that transmitted the received capability request command (E01). The MFP 1 can obtain information indicating a requester as, for example, User-Agent information associated with the capability request command in communication in accordance with IPP. The User-Agent information is an example of identification information for identifying an IPP client.

In the present embodiment, when the support program 142 of the PC 100 instructs the general-use printing program 141 to transmit the capability request command (for example, A12 in FIG. 2), the support program 142 may add, in association with the capability request command, User-Agent information indicating the support program 142 itself. In this case, the MFP 1 obtains information indicating the support program 142 in E01. When the support program 142 does not add User-Agent information, the User-Agent information becomes information indicating an OS of a transmission source. For example, since the OS 121 of the PC 100 is Windows®, information indicating “wPrintWindowDoc” is added, as User-Agent information, to a capability request command transmitted from the PC 100.

On the other hand, since the OS 201 of the PC 200 is not Windows, User-Agent information different from the User-Agent information added to a capability request command transmitted from the PC 100 is added to the capability request command transmitted from the PC 200. For example, information indicating “CUPS2.3.4” and “macOS14.4” is added, as User-Agent information, to a capability request command transmitted from the PC 200.

Based on the User-Agent information added to the capability request command, the CPU 11 determines whether a transmission source of the capability request command is the support program 142 or Windows® (E02). When the CPU 11 determines that the transmission source is the support program 142 or Windows® (E02: YES), the CPU 11 obtains one parameter included in the received capability request command (E05).

The CPU 11 determines whether the obtained parameter is a parameter that instructs execution of the process (E10). When the CPU 11 determines that the obtained parameter is a parameter that instructs execution of the process (E10: YES), the CPU 11 executes a parameter execution process (E11). The parameter execution process of E11 is the same process as C22 in the response capability determination process of the first embodiment and follows the procedure shown in FIG. 7. By the parameter execution process of E11, result information indicating any of success, a processing error, and a timing error is added to the capability information.

After completion of the parameter execution process of E11, or when the CPU 11 determines that the obtained parameter is not a parameter that instructs execution of the process (E10: NO), the CPU 11 adds, to the capability information, the defined capability values and the proprietary capability values corresponding to the obtained parameter (E12).

For example, User-Agent information indicating the support program 142 or Windows® is added to the capability request command transmitted from the PC 100. That is, when the CPU 11 receives the capability request command from the PC 100, the CPU 11 determines YES in E02. Then, when the parameter included in the capability request command is a processing parameter that instructs execution of the process, the CPU 11 executes the instructed process.

Further, when the CPU 11 determines YES in E02, even if the parameter included in the capability request command is the defined parameter, the CPU 11 replies with the defined capability values and the proprietary capability values corresponding to the parameter. For example, when the capability request command includes the defined parameter requesting a capability of a color mode, the CPU 11 adds, to the capability information, all of the defined capability values (auto, color, and monochrome) and all of the proprietary capability values (custom_normal, custom_vivid, and custom_none).

Then, the CPU 11 determines whether there is an unchecked parameter (E13). When the CPU 11 determines that there is an unchecked parameter (E13: YES), the CPU 11 proceeds to E05 and obtains a next parameter.

Also in the present embodiment, the MFP 1 is capable of receiving the capability request command that includes no parameter. Even when the capability request command includes no parameter or includes “all,” when the CPU 11 determines YES in E02, the CPU 11 replies, to a transmission source of the command, with the capability information including all defined capability values and all proprietary capability values. For example, the CPU 11 may reply with the capability information including also the proprietary capability value for which there is no corresponding defined parameter. Further, when the capability request command includes a parameter specifying a particular group, the CPU 11 replies, to the transmission source of the command, with the capability information including all defined capability values and all proprietary capability values corresponding to the group specified by the parameter.

On the other hand, when the CPU 11 determines that the User-Agent information of the capability request command is neither that of the support program 142 nor that of Windows® (E02: NO), the CPU 11 obtains one parameter included in the received capability request command (E21). Then, the CPU 11 adds only the defined capability value corresponding to the obtained parameter to the capability information (E22). When the CPU 11 determines NO in E02, the received capability request command does not include a processing parameter. Also, even if the received capability request command included a processing parameter, the CPU 11 does not execute the process.

For example, User-Agent information indicating the support program 142 or Windows® is not added to the capability request command transmitted from the PC 200. That is, when the CPU 11 receives the capability request command from the PC 200, the CPU 11 determines NO in E02 and replies with only the defined capability values. For example, when the capability request command received from the PC 200 includes the defined parameter requesting the capability of the color mode, the CPU 11 replies with the capability information including only the defined capability values auto, color, and monochrome. Further, for example, when the capability request command received from the PC 200 includes no parameter or includes “all,” the CPU 11 replies with the capability information including all defined capability values.

Then, the CPU 11 determines whether there is an unchecked parameter (E23). When the CPU 11 determines that there is an unchecked parameter (E23: YES), the CPU 11 proceeds to E21 and obtains a next parameter. When the CPU 11 determines that all parameters have been checked (E13: NO or E23: NO), the CPU 11 ends the response capability determination process and returns to the printing procedure illustrated in FIG. 2.

As described above, the MFP 1 of the present embodiment replies with a proprietary capability value indicating an expanded function only to an IPP client that uses an IPP Class Driver that does not require recertification. Accordingly, the MFP 1 of the present embodiment does not need to undergo recertification even when an update is performed.

By obtaining the capability information including the proprietary capability values, the support program 142 of the present embodiment determines, as a set of options that can be received as print settings, a set of options corresponding to the proprietary capability values, similarly to the support program 142 of the first embodiment. Then, the support program 142 causes the print setting screen 60 (see FIG. 9) that allows selection of print setting values from the determined set of options to be displayed, and becomes capable of receiving print settings by the user. Thereafter, the support program 142 is capable of causing the MFP 1 to transmit a print job specifying print setting values selected by the user, similarly to the first embodiment.

As described above in detail, when User-Agent information indicating the support program 142 or Windows® has been associated with the received capability request command, the MFP 1 of the other embodiment is capable of both replying with capability information of the MFP 1 and executing the process, in accordance with parameters included in the capability request command. Accordingly, even the PC 100 that does not use a printer driver can instruct execution of the process executable by the MFP 1, and therefore use of proprietary capabilities originally provided in the MFP 1 can be expected.

Further, when a transmission source of the capability request command is the support program 142 or Windows®, the MFP 1 of the other embodiment replies with capability information including a proprietary capability value. Accordingly, even in the MFP 1 of the other embodiment, as in the MFP 1 of the first embodiment, the proprietary capability originally provided in the MFP 1 becomes available when executing the print job transmitted from the PC 100, which is an IPP client.

In addition, in the present embodiment, it is unnecessary to prepare the proprietary parameter. Accordingly, the MFP 1 does not need to consider correspondence between the proprietary parameter and the defined parameter. Further, the support program 142 does not need to include the proprietary parameter, thereby simplifying processes. On the other hand, in the first embodiment, a relationship between a parameter included in a capability request command and a capability value to be replied with is simple. Accordingly, processes of the MFP 1 are simplified. Further, since the support program 142 is capable of selectively including a proprietary parameter only for an item for which a proprietary capability value is required, a communication load may be reduced.

The embodiments disclosed in this specification are merely examples and do not limit the present invention in any manner. Accordingly, the technology disclosed in this specification can naturally be variously improved and modified within a range that does not depart from the gist thereof. For example, the printer may be any device that includes a printing function and a communication function compliant with IPP, and is not limited to the MFP 1, and may be a single-function printing device, a copier, or a facsimile device. Further, the IPP client is not limited to a PC, and may be, for example, a smartphone or a tablet computer.

For example, the print setting screens illustrated in FIG. 9 and FIG. 10 are merely examples, and are not limited to the configurations shown in those figures. Further, for example, instead of displaying a unique print setting screen, the support program 142 may provide information of a print setting screen as a part of a screen displayed by the general-use printing program 141. Further, for example, by providing the general-use printing program 141 with information indicating options, the support program 142 may cause the general-use printing program 141 to display the print setting screen. In this case, when an option corresponding to the defined capability value is selected, the general-use printing program 141 may perform the process, and when an option corresponding to the proprietary capability value is selected, the support program 142 may perform the process.

The types of processing parameters and examples of result information returned in response thereto are merely examples and are not limited to the examples disclosed in this specification. For example, in a case of a processing error, the MFP 1 may be capable of replying with result information including information indicating a cause of the error.

For example, instead of instructing the general-use printing program 141 to transmit the capability request command or the print job to the MFP 1, the support program 142 may transmit the capability request command or the print job directly to the MFP 1.

In the embodiments, as an operation of the support program 142, only an operation relating to printing is described in detail. However, the support program 142 may further have other roles. Further, a program that executes a process of the present embodiment is not limited to the support program 142, and may be any program that receives an instruction from the OS 121 or the general-use printing program 141 when printing is performed using the general-use printing program 141. For example, the program may be a print workflow app (Print workflow) whose specification has been published by Microsoft®.

A timing at which the support program 142 is executed is not limited to the examples of the embodiments. For example, the support program 142 may be executed based on a direct execution instruction from the OS 121, or may be a resident support program 142. When the support program 142 is resident, the support program 142 may perform the above-described operations upon receiving an execution instruction.

In any flowchart disclosed in the embodiments, multiple types of processes in any plurality of steps can be executed in a different order, or can be executed in parallel, as long as no inconsistency arises in processing contents.

The processes disclosed in the embodiments may be executed by a single CPU, by a plurality of CPUs, by hardware such as an ASIC, or by a combination thereof. Further, the processes disclosed in the embodiments can be implemented in various forms, such as a recording medium storing a program for executing the processes, or a method.

What is claimed is:

1. A printer comprising:
a printing engine; and
a communication interface,
wherein the printer is configured to, in accordance with Internet Printing Protocol (IPP), receive a print job from an IPP client through the communication interface and cause the printing engine to perform printing based on the received print job,
wherein the printer is configured to, in response to receiving a specific command from the IPP client through the communication interface, the specific command being defined by an IPP standard and requesting capability information, return the capability information indicating a capability of the printer, the specific command being capable of including a parameter, the parameter having a plurality of types, and the plurality of types including a capability parameter specifying a capability and a processing parameter specifying a process, and
wherein the printer is further configured to:
in a case where the received specific command includes the capability parameter, return the capability information indicating a capability specified by the capability parameter among capabilities of the printer; and
in a case where the received specific command includes the processing parameter, execute the process specified by the processing parameter.

2. The printer according to claim 1,
wherein the processing parameter is a parameter that is not defined in the IPP standard, and
wherein the printer is configured to, in a case where the received specific command includes the processing parameter in a format defined by the IPP standard, execute the process specified by the processing parameter.

3. The printer according to claim 2,
wherein the printer is configured to, in a case where the received specific command includes the processing parameter in the format defined by the IPP standard, execute the process specified by the processing parameter, and return a processing result of the executed process in a format defined by the IPP standard through the communication interface as a response to the received specific command.

4. The printer according to claim 2,
wherein the printer is configured to, in a case where the received specific command includes the processing parameter in the format defined by the IPP standard, return information indicating that execution of the process specified by the processing parameter has been received in the format defined by the IPP standard through the communication interface as a response to the received specific command.

5. The printer according to claim 3,
wherein the printer is configured to, in a case where the received specific command includes the capability parameter, return information including a capability specified by the capability parameter among capabilities of the printer in the format defined by the IPP standard through the communication interface as a response to the received specific command.

6. The printer according to claim 1,
wherein the printer is configured to, in a case where the received specific command includes an instruction to execute test printing as the processing parameter, execute the test printing specified by the processing parameter.

7. The printer according to claim 1,
wherein the printer is configured to, in a case where the received specific command includes an instruction to start a preparatory operation of the printing engine as the processing parameter, start the preparatory operation specified by the processing parameter.

8. The printer according to claim 1,
wherein the printer is configured to, in a case where the received specific command includes an instruction to execute color calibration as the processing parameter, execute the color calibration specified by the processing parameter.

9. The printer according to claim 1,
wherein, in a case where the received specific command includes the processing parameter, the printer is configured to:
execute the process specified by the processing parameter when a particular time has elapsed since a previous execution of the process specified by the processing parameter; and
not execute the process specified by the processing parameter when the particular time has not elapsed since the previous execution of the process specified by the processing parameter.

10. The printer according to claim 9,
wherein, in a case where the received specific command includes the processing parameter, the printer is configured to, when the particular time has not elapsed since a previous execution of the process specified by the processing parameter, not execute the process specified by the processing parameter, and return error information indicating that the particular time has not elapsed since the previous execution through the communication interface as a response to the received specific command.

11. The printer according to claim 1,
wherein the printer is configured to:
in a case where the received specific command includes the capability parameter, return the capability information; and
in a case where the received specific command does not include the capability parameter and includes the processing parameter, not return the capability information, execute the process specified by the processing parameter, and return information based on execution of the process.

12. A printer comprising:
a printing engine; and
a communication interface,
wherein the printer is configured to, in accordance with Internet Printing Protocol (IPP), receive a print job from an IPP client through the communication interface and cause the printing engine to perform printing based on the received print job,
wherein the printer is configured to, in response to receiving a specific command from the IPP client through the communication interface, the specific command being defined by an IPP standard and requesting capability information, return the capability information indicating a capability of the printer, identification information for identifying the IPP client as a requester being associated with the specific command, the specific command being capable of specifying a process, and
wherein the printer is further configured to:
in a case where the received specific command has been associated with the identification information indicating a first type IPP client, be capable of returning the capability information and executing the process specified by the specific command; and
in a case where the received specific command has been associated with the identification information indicating a second type IPP client, be capable of returning the capability information, while not executing the process specified by the specific command.

13. The printer according to claim 12,
wherein the specific command is configured to specify at least one of a capability and a process, and
wherein, in a case where the received specific command has been associated with the identification information indicating the first type IPP client, the printer is configured to:
return the capability information indicating the specified capability when the capability is specified by the specific command; and
execute the specified process when the process is specified by the specific command.

14. The printer according to claim 13,
wherein, in a case where the received specific command has been associated with the identification information indicating the first type IPP client implemented in a particular operating system, the printer is configured to:
return the capability information indicating the specified capability when the capability is specified by the specific command; and
execute the specified process when the process is specified by the specific command.

15. The printer according to claim 14,
wherein, in a case where the received specific command has been associated with the identification information indicating the first type IPP client implemented in Windows as the particular operating system, the printer is configured to:
return the capability information indicating the specified capability when the capability is specified by the specific command; and
execute the specified process when the process is specified by the specific command.

16. The printer according to claim 13,
wherein, in a case where the received specific command has been associated with the identification information indicating the first type IPP client that transmits the specific command in cooperation with a print support program, the printer is configured to:
return the capability information indicating the specified capability when the capability is specified by the specific command; and
execute the specified process when the process is specified by the specific command.
